(19) United States
(12) Patent Application Publication
(10) Pub. No.: US 2005/0058307 A1
(43) Pub. Date: Mar. 17, 2005

(54) Method and apparatus for constructing audio stream for mixing, and information storage medium

(75) Inventors: Jong-ho Yang, Gwacheon-si (KR); Kil-soo Jung, Taean-eup (KR); Jung-wan Ko, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-Si (KR)

(21) Appl. No.: 10/883,983

(22) Filed: Jul. 6, 2004

(30) Foreign Application Priority Data
Jul. 12, 2003 (KR) 2003-47535
Jul. 15, 2003 (KR) 2003-48427

(51) Int. Cl. H04B 1/00; G06F 17/00

(52) U.S. Cl. 381/119; 700/94; 369/4

(57) ABSTRACT

An information storage medium that contains audio mixing information, which includes a multiplicity of audio channel components containing audio data, and the mixing information is used to mix the audio channel components and additional channel components to be added. Accordingly, it is possible to mix different channel components from different audio streams and reproduce an audio stream using an apparatus and/or a method.

### CROSS-REFERENCE TO RELATED APPLICATIONS

This application claims the benefit of Korean Patent Application No. 2003-47535, filed on Jul. 12, 2003 in the Korean Intellectual Property Office, and Korean Patent Application No. 2003-48427, filed on Jul. 15, 2003 in the Korean Intellectual Property Office, the disclosures of which are incorporated herein in their entirety by reference.

### BACKGROUND OF THE INVENTION

1. Field of the Invention

The present invention relates to audio mixing, and more particularly, to a method and apparatus for constructing an audio stream enabling mixing of a multiplicity of audio data obtained from respective multiple channels, and an information storage medium therefor.

2. Description of the Related Art

FIG. 1 is a schematic view of a conventional user interface that adjusts the volume of an audio player installed in a personal computer (PC) or the like. A user can adjust the volume of the audio player using a volume control interface as shown in FIG. 1. When the user adjusts the volume of the audio player by raising or lowering a volume button 100 with a keyboard or a mouse, audio mixing is performed on audio data obtained from respective multiple audio stream channels. However, audio mixing is arbitrarily determined by the audio player, regardless of the number and types of audio stream channels.

For instance, when reproducing an audio stream containing audio data obtained from two channels, the output levels of first audio data from a first channel and second audio data from a second channel are predetermined in the audio player. Thus, the output levels of the first and second audio data are adjusted to the preset output levels and the first and second audio data having adjusted output-levels are mixed.

However, the above arbitrary audio mixing has some problems. Mixing the first audio data and the second audio data from two separate channels at desired output levels as the content provider desires is extremely difficult. This is because coefficients for adjusting the output levels of audio data are predetermined in an audio player installed in a PC. Therefore, it is almost impossible to appropriately reflect a content producer's intention in audio mixing.

Also, once an audio mixing method is determined with respect to audio content, such as the words of a song or a movie script, the mixing method is maintained until completion of reproduction thereof. That is, it is impossible to dynamically change the audio mixing method performed on audio content. Thus, no adaptation can be made to any audio content or characteristics.

Furthermore, only the same type of channel components can be mixed when mixing channel components of one type of audio content with those components of another type of audio content. In other words, even though content providers want to provide audio contents obtained by mixing audio data from different channels, it is impossible to reproduce such audio contents. In particular, if one type of audio content contains multichannel data and another type of audio content contains two-channel data, it is difficult to mix the two-channel data with the surround component of the multichannel data without changing the channel format of the two-channel data. For example, it is difficult for a content provider to adjust MP3 music to a desired output level, and mix the MP3 music with surround multichannel channel audio data contained in DVD-Video.

### SUMMARY OF THE INVENTION

According to an aspect of the present invention, the a method and apparatus are provided for constructing an audio stream enabling mixing of audio channel components from different types of audio streams, and an information storage medium that stores audio mixing information.

According to an aspect of the present invention, there is provided an information storage medium including a multiplicity of audio channel components each containing corresponding audio data, and mixing information that is used to mix additional channel components to be added and the audio channel components.

In an aspect of the present invention, the mixing information includes a field in which information regarding the additional channel components is recorded, and predetermined dummy values may be set in the field.

According to another aspect of the present invention, there is provided an information storage medium including a multiplicity of audio channel components containing audio data, and an audio stream containing at least one null channel component which provides a spare space for recording predetermined audio data.

According to an aspect of the present invention, audio data contained in the null channel component includes mixing information that is referred to when the audio data contained in the null channel component is mixed with a channel component from at least one of the multiplicity of audio channels.

According to another aspect of the present invention, there is provided an apparatus including a main demultiplexer that demultiplexes a main audio stream including a multiplicity of main audio channels containing audio data and at least one null channel that provides a space for storing predetermined audio data, and outputs the demultiplexed audio stream in the audio channels; an auxiliary demultiplexer that demultiplexes an auxiliary audio stream including at least one auxiliary audio channel containing audio data, which is to be contained in the null channel, and outputs the demultiplexed audio stream in the auxiliary audio channels; a mapper that replaces one of the at least one null channels output from the main demultiplexer with one of the at least one auxiliary audio channels output from the auxiliary demultiplexer; and a multiplexer that multiplexes the auxiliary audio channels output from the mapper and the main audio channels output from the main demultiplexer and outputs a combined audio stream.

In an aspect of the present invention, the apparatus includes a decoder that decodes the combined audio stream, and a mixer that mixes the audio channels decoded by the decoder based on the mixing information.

According to still another aspect of the present invention, there is provided an apparatus including a decoder that decodes a combined audio stream having a multiplicity of main audio channels which form an audio stream having a predetermined format, and auxiliary audio channels to be mixed with one of the multiplicity of main audio channels; and a mixer that mixes audio data from the auxiliary audio channels and the main audio channels based on mixing information.

According to still another aspect of the present invention, there is provided a method of constructing an audio stream, including creating at least one main audio channel component; and constructing the audio stream by packaging mixing information used to mix the created main audio channel component and additional channel components to be added.

According to an aspect of the present invention, the constructing the audio stream includes creating the mixing information to include fields for recording information regarding the additional channel components, or includes mixing information to include fields for recording information regarding the additional channel components, the information setting the fields to predetermined dummy values.

According to still another aspect of the present invention, there is provided a method of constructing an audio stream, including creating at least one main audio channel, and creating a main audio stream that contains the created main audio channel component and at least one null channel component.

According to an aspect of the present invention, the method includes creating at least one auxiliary audio channel component, and creating a combined audio stream by replacing the created auxiliary audio channel component with the null channel component.

According to still another aspect of the present invention, there is provided a method of constructing an audio stream, including creating at least one main audio channel component, creating at least one auxiliary audio channel component, and creating a combined audio stream with the created main audio channel component and auxiliary audio channel component.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic view of a conventional user interface for adjusting the volume of an audio player installed in a personal computer (PC) or the like;

FIG. 2 is a block diagram of an apparatus for constructing an audio stream, according to an embodiment of the present invention;

FIG. 3 is a block diagram of an apparatus for constructing an audio stream according to another embodiment of the present invention;

FIG. 4A is a schematic view of a main audio stream according to an embodiment of the present invention;

FIG. 4B is a schematic view of a main audio stream according to another embodiment of the present invention;

FIG. 4C is a schematic view of a main audio stream according to yet another embodiment of the present invention;

FIG. 4D is a schematic view of a main audio stream according to still another embodiment of the present invention;

FIG. 4E is a schematic view of a main audio stream according to still another embodiment of the present invention;

FIG. 5 is a schematic view of an auxiliary audio stream according to an embodiment of the present invention;

FIG. 6A is a schematic view of a combined audio stream according to an embodiment of the present invention;

FIG. 6B is a schematic view of a combined audio stream according to another embodiment of the present invention;

FIG. 7 is a block diagram of another embodiment of the apparatus of FIG. 3 that reproduces the combined audio streams shown in FIGS. 6A and 6B;

FIGS. 8A and 8B are a schematic view of and a block diagram of an example of a system in which an apparatus for constructing an audio stream is built;

FIG. 9 illustrates a data structure which mixes information according to an embodiment of the present invention;

FIG. 10A illustrates a mixing table containing the mixing information of FIG. 9, according to an embodiment of the present invention;

FIG. 10B illustrates a mixing table containing the mixing information of FIG. 9, according to another embodiment of the present invention; and

FIG. 11 is a reference diagram illustrating dynamic mixing according to an embodiment of the present invention.

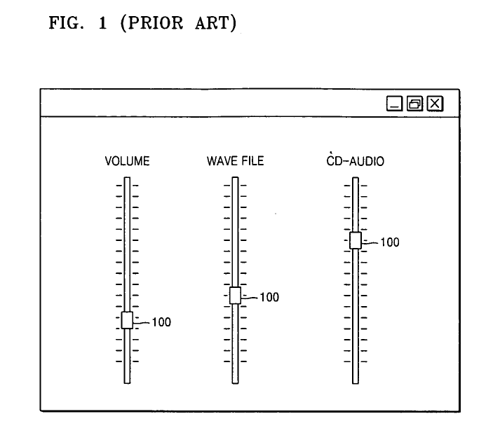

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

For a better understanding of embodiments of the present invention, ‘mixing’ will first be briefly explained. Mixing can be understood as at least one of the following: (i) adjusting the output levels of at least channel component of a multiplicity of channel components constituting an audio stream; (ii) adjusting the output levels of at least one respective channel component of a multiplicity of channel components constituting an audio stream, and combining the adjusted channel component with at least one channel component among the remaining channel components; and (iii) combining at least two channel components of a multiplicity of channel components constituting an audio stream, and outputting the combination result to a speaker. Also, mixing methods (i) through (iii) are applicable to at least one channel component of a multiplicity of channel components constituting a multiplicity of audio streams. Further, dynamic mixing is encompassed by reference to ‘mixing’ according to embodiments of the present invention.

An audio stream is a unit of audio data that is produced in a predetermined format to enable evaluation of a complete piece of audio such as a song or a piece of music. That is, an audio stream is audio data that can be independently reproduced and contains at least one channel component. Here, a channel component represents audio data contained in a channel.

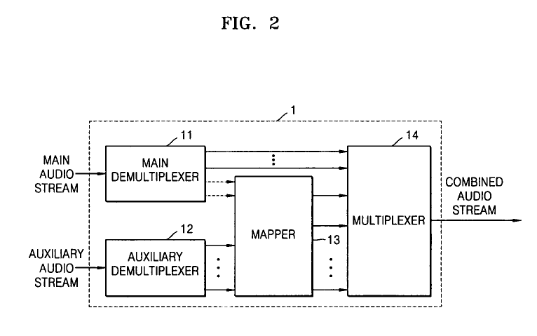

FIG. 2 is a block diagram of an apparatus 1 for constructing an audio stream, according to an embodiment of the present invention. Referring to FIG. 2, the apparatus 1 includes a main demultiplexer 11, an auxiliary demultiplexer 12, a mapper 13, and a multiplexer 14. The apparatus receives a main audio stream and an auxiliary audio stream and produces a combined audio stream.

The main demultiplexer 11 receives and demultiplexes the main audio stream and outputs a multiplicity of audio channel components. The main audio stream is an audio stream produced in an information format (i.e., an extensible format that allows the addition of at least one among a multiplicity of channel components that constitute another audio stream). In FIG. 2, solid lines denote the audio channel components obtained from the main audio stream and dotted lines denote channel components that can be added to the existing channel components. As will be described later, the dotted lines denote null channel components in a case where the main audio stream has at least one null channel to which a channel component is added.

The auxiliary demultiplexer 12 receives and demultiplexes the auxiliary audio stream and outputs a multiplicity of auxiliary audio channel components. In this embodiment, the auxiliary audio stream does not contain null channel components. However, it is understood that the auxiliary audio stream may contain null channel components.

The main demultiplexer 11 and the auxiliary demultiplexer 12 are so named because they demultiplex the main audio stream and the auxiliary audio stream, respectively. Accordingly, they must not be understood as a main apparatus and its auxiliary apparatus.

The mapper 13 exchanges at least one channel component, which can be added to the existing channel components, output from the main multiplexer 11 for at least one auxiliary audio channel component output from the auxiliary demultiplexer 12. In other words, the mapper 13 inserts audio data contained in an auxiliary audio channel into the main audio stream. In the event that the main audio stream has a null channel, the mapper 13 inserts the audio data contained in the auxiliary audio channel into the null channel, thus exchanging a null channel component for the auxiliary audio channel component. During the exchange, the mapper 13 may reformat the audio data contained in the auxiliary audio channel into a predetermined format, e.g., a format into which audio data contained in the main audio channel is formatted, and insert the reformatted audio data into the null channel.

The multiplexer 14 multiplexes the auxiliary audio channel components, which are substituted for the null channel components, output from the mapper 13 and the main audio channel components output from the main demultiplexer 11 and outputs a combined audio stream as the result of the multiplexing. In this case, the multiplexer 14 may insert mixing information into the combined audio stream. However, if a reproducing apparatus contains mixing information, it is not required to insert the mixing information into the combined audio stream in all aspects of the invention.

The combined audio stream is an independent audio stream comprising a multiplicity of main audio channel components completing a predetermined format and auxiliary audio channel components to be mixed with the main audio channel components. Here, completing the predetermined format indicates that all data required in the predetermined format is prepared. For instance, when all of the five-channel components specified in the Dolby AC3 format are prepared, a predetermined format is completed. However, it is understood that other formats, such as DVD-Audio, MPEG, Dolby PROLOGIC, MP3, WINDOWS MEDIA, etc. can also be used.

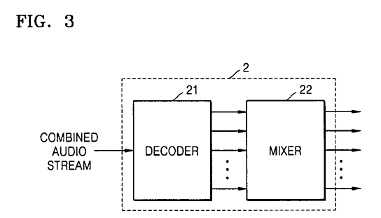

FIG. 3 is a block diagram of an apparatus for reproducing an audio stream 2, according to another embodiment of the present invention. Referring to FIG. 3, the apparatus for reproducing the audio stream 2 includes a decoder 21 and a mixer 22 so as to reproduce a combined audio stream. The decoder 21 decodes the combined audio stream and outputs a multiplicity of decoded main audio channel components and at least one auxiliary audio channel component. The mixer 22 mixes the at least one auxiliary audio channel component and one of the multiplicity of main audio channel components. Here, mixing is performed in accordance with a predetermined mixing method or performed based on mixing information that will be described below in greater detail. If there is more than one type of mixing information, the mixer 22 performs dynamic mixing, which is different to only one type of mixing performed on only one combined audio stream. Dynamic mixing will be described below in more detail.

Since different formats of audio channel components are decoded at different speeds, the amount of decoded audio channel components output from the decoder 21 may not be the same. To solve this problem, the mixer 22 may include a buffer (not shown) or some similar storage device that appropriately buffers audio data prior to mixing.

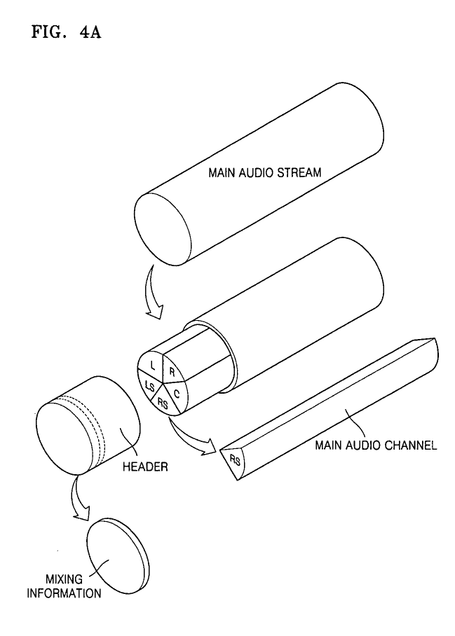

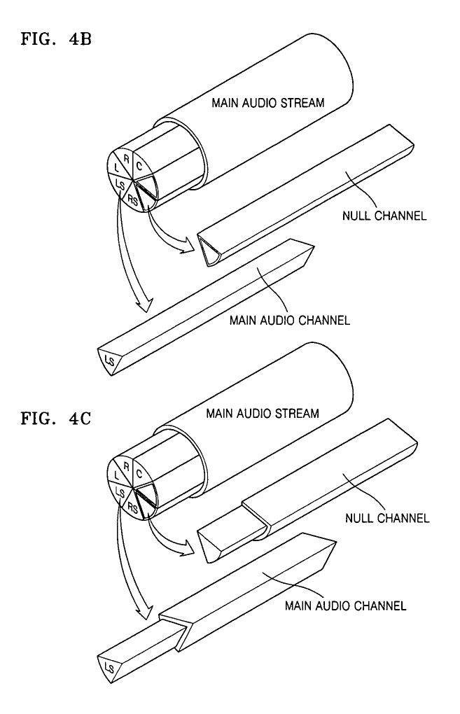

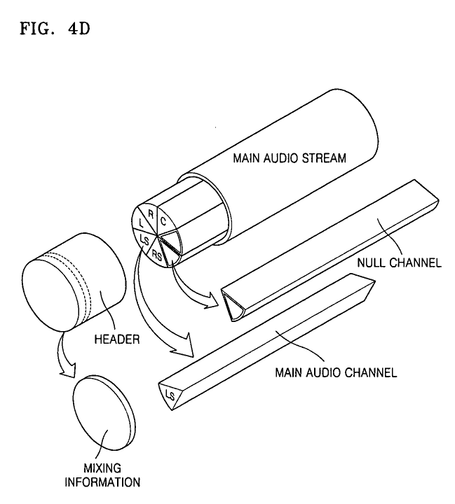

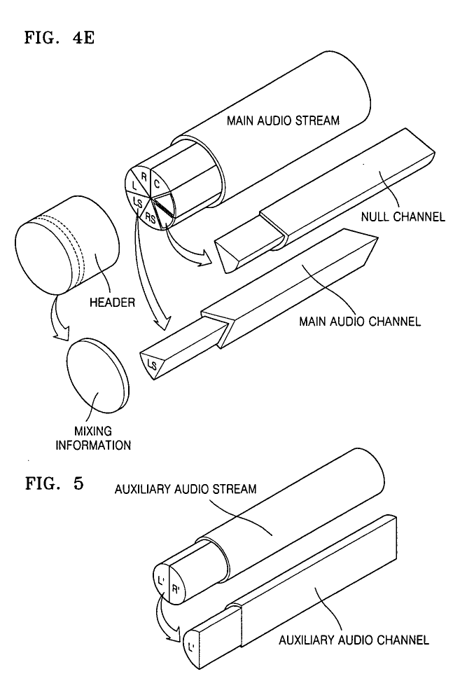

FIGS. 4A and 4B illustrate embodiments of a main audio stream. In this example, the main audio stream will be described with respect to five channels. However, the number of channels is not limited and may be changed depending on the type of format. For example, 6 or 8 channel surround sound channels may also be used.

Referring to FIG. 4A, a main audio stream has five different main audio channels L, C, R, LS, and RS. Here, the five different main audio channels L, C, R, LS, and RS denote a left channel, a central channel, a right channel, a left-surround channel, and a right-surround channel, respectively. The main audio channels L, R, and C provide stable virtual sound sources and the main audio channels LS and RS provide three-dimensional (3D), realistic sound sources.

In this embodiment, mixing information is recorded in a header of the main audio stream. The mixing information enables an extension of the main audio stream. In other words, the mixing information makes it possible to insert a predetermined channel component of another audio stream into the main audio stream, thereby extending the main audio stream. The mixing information is information that allows the mixing of a predetermined channel component, which will be added later, and a main audio channel component of the existing main audio stream. A detailed data structure of the mixing information will be later described.

Referring to FIG. 4B, a main audio stream has five different main audio channels L, C, R, LS, and RS explained with reference to FIG. 4A, and further has two null channels. The two null channels provide spaces for containing predetermined audio data. In this embodiment, the null channels do not contain data.

Referring to FIG. 4C, a main audio stream has five different main audio channels and two null channels as explained with respect to FIG. 4B. However, the two null channels contain null data which is meaningless data such as a series of 0's or audio data. Reproduction of the audio data as null data provides additional audio. However, even if null audio data is not reproduced, the quality of the main audio stream is not largely affected. Meanwhile, even if audio data obtained from only one of the main audio channels is not reproduced, the quality of the main audio stream deteriorates.

Referring to FIG. 4D, a main audio stream also has five different main audio channels and two null channels as explained with respect to FIG. 4B. However, mixing information is further recorded in a header of the main audio stream of FIG. 4D. As previously mentioned, the mixing information enables mixing of a predetermined channel component, which will be added later, and a main audio channel component of the existing main audio stream.

Referring to FIG. 4E, a main audio stream has five different main audio channels and two null channels as explained with respect to FIG. 4C. However, mixing information is further recorded in a header of the main audio stream of FIG. 4E. As described above, the mixing information enables mixing of a predetermined channel component, which will be added later, and a main audio channel component of the existing main audio stream.

FIG. 5 is a schematic view of an auxiliary audio stream according to another embodiment of the present invention. Referring to FIG. 5, the auxiliary audio stream is an audio stream with left and right channels L′ and R′. That is, the auxiliary audio stream contains audio data obtained from two channels. The shown auxiliary audio stream (i.e., two-channel audio stream) enables reproduction of sound that echoes in the right and left directions. Here, the auxiliary audio stream is named for convenience, since its channel component is inserted into a main audio stream. That is, the auxiliary audio stream is an audio stream that can be independently reproduced without the main audio stream. The total number of channels for the auxiliary audio stream is not limited to two and can be changed according to the type of format. Moreover, the auxiliary audio channels need not be for left and right, but instead may be for a single channel, such as a center channel or subwoofer channel, or auxiliary inputs to front and back or left and right channels.

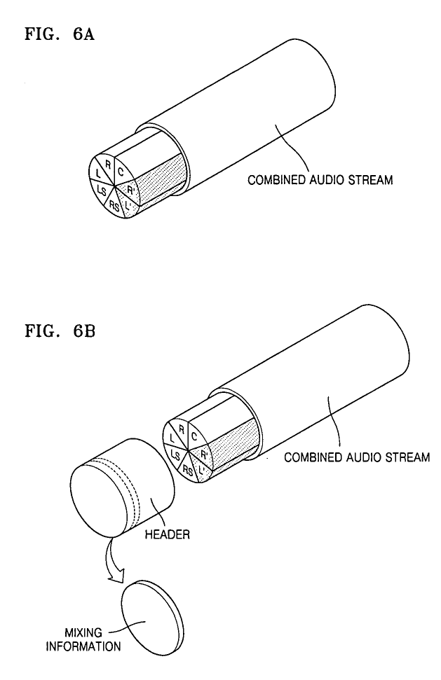

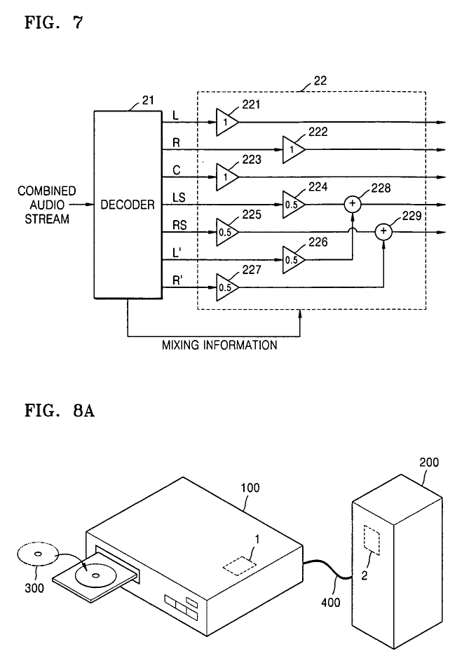

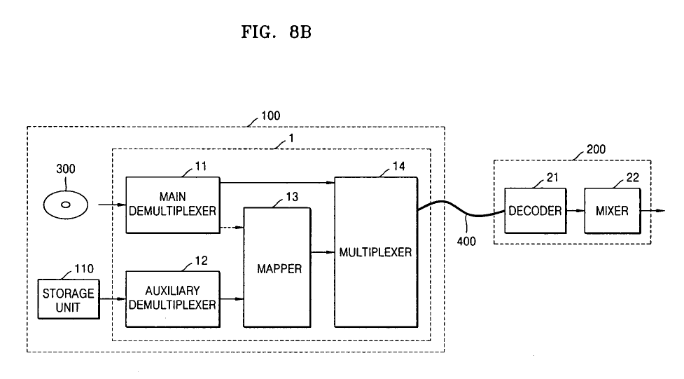

FIGS. 6A and 6B show combined audio streams according to preferred embodiments of the present invention. The combined audio stream of FIG. 6A is a combination of the main audio stream shown in FIGS. 4A through 4E and the auxiliary audio stream of FIG. 5. More specifically, the combined audio stream is obtained by inserting channel components output from the two auxiliary channels L′ and R′ into the main audio stream. If the main audio stream has two null channels, the combined audio stream may be obtained by replacing the null channel components from the null channels with the auxiliary channel components from the channels L′ and R′.

An audio stream producer may directly construct a combined audio stream in the above format without using an apparatus. In this embodiment, the combined audio stream is a small amount of digital data and can be obtained by mixing main audio channel components and auxiliary audio channel components or may include only main audio channel components without auxiliary audio channel components.

The combined audio stream of FIG. 6B is the same as that of FIG. 6A, but further includes mixing information in a header. The mixing information is referred to when the main audio channel components are mixed with the auxiliary audio channel components. The mixing information may also be generated by a reproducing apparatus and inserted into the header of the combined audio stream, or may be generated in accordance with an intention of an audio stream producer and inserted into the header of the combined audio stream according to aspects of the present invention. Here, the apparatus for reproducing the audio stream 2 generates the mixing information as desired by a user.

FIG. 7 is a block diagram of an apparatus for reproducing the combined audio stream of FIG. 6A or 6B, the apparatus being another embodiment of the apparatus of FIG. 3. The same elements as those in FIG. 3 will be indicated with the same reference numerals and their structures or functions described with reference to FIG. 3 will be omitted.

The apparatus of FIG. 7 decodes a combined audio stream according to an embodiment of the present invention and mixes the result of decoding based on mixing information recorded in a header of the combined audio stream. The apparatus of FIG. 7 includes a decoder 21 and a mixer 22.

The decoder 21 decodes audio data output from five main audio channels contained in the combined audio stream and audio data output from two auxiliary audio channels and outputs the decoded data in channels. Also, the decoder 21 reads the mixing information from the header of the combined audio stream and provides it to the mixer 22. If necessary, the decoder 21 decodes the audio data based on the mixing information. However, the decoder 21 does not need to use the mixing information in all aspects of the invention.

The mixer 22 includes amplifiers 221 through 227 that amplify the output levels of the audio data output from the decoder 21 and includes adders 228 and 229 that combine audio data from at least two channels. The adders 228 and 229 are specified as an example, but there is no restriction to the number of adders. If necessary, the mixer 22 includes more adders for combining audio data from channels not shown in FIG. 4 so as to mix with others of the L, R, C channels instead of or in addition to the LS, RS channels illustrated in FIG. 4.

Based on mixing information, the mixer 22 uses the amplifiers 221 through 223 to multiply the output levels of audio data from channels L, R, and C, which are input from the decoder 21, by a mixing coefficient of 1, and uses the amplifiers 224 and 225 to multiply the output levels of audio data from channels LS and RS by a mixing coefficient of 0.5. Similarly, based on the mixing information, the mixer 22 uses the amplifiers 226 and 227 to multiply the output levels of audio data from auxiliary channels L′ and R′, which are input from the decoder 21, by a mixing coefficient of 0.5. Next, the mixer 22 uses the adders 228 and 229 to combine the audio data from the auxiliary channels L′, R′ having adjusted output levels with the audio data from the channels LS and RS. That is, the audio data from the auxiliary channels L′ and R′ of the auxiliary audio stream are combined with the audio data from the channels LS and RS of the main audio stream, respectively. The results of the combinations are output via the channels LS and RS. Thus, the mixer 22 outputs final audio data via the five channels L, R, C, LS, and RS.

FIGS. 8A and 8B are a schematic view of and a block diagram of a system in which an apparatus for constructing and/or reproducing an audio stream is installed. The same elements as those in FIGS. 2 and 3 are indicated with the same reference numerals and their structures or functions described with reference to FIGS. 2 and 3 will be omitted.

Referring to FIGS. 8A and 8B, the system includes an audio player 100 and an amplifier 200. The audio player 100 and the amplifier 200 are connected via a transmission line 400 capable of transmitting digital data. For instance, the transmission line 400 may be a Sony Philips Digital Interface (SPDI) connector. While illustrated in FIG. 8A as an audio player 100, it is understood that audio/video players, or a computer or portable music device such as an MP3 player may also be used. Furthermore, it is understood that the transmission between the audio player 100 and the amplifier 200 may be wireless and is not limited to any particular type of transmission line.

The apparatus 1 of FIG. 2 and a disc drive are installed in the audio player 100. The disc drive reads a main audio stream according to the present invention from a disc-type information storage medium 300 loaded into the disc drive. Also, the audio player 100 includes a storage unit 110 in which an auxiliary audio stream is stored. The storage medium 110 may be a hard disc or a memory. The apparatus for reproducing an audio stream 2 of FIG. 3 is installed in the amplifier 200. The information storage medium may be, for example, a CD-R, CD-ROM, DVD, Bluray, Advanced Optical Disc (AOD) and/or memory such as flash memory. Alternatively, it is understood that the audio streams may be received over a network, such as the Internet, a LAN, WLAN, etc.

The main audio stream recorded on the disc-type information storage medium 300 is provided to a main demultiplexer 11 and the auxiliary audio stream stored in the storage unit 110 is provided to an auxiliary demultiplexer 12. A multiplexer 14 transmits a combined audio stream to the amplifier 200 via the transmission line 400. As previously mentioned, the amplifier 200 decodes the combined audio stream and mixes the results of decoding.

In order to reproduce the channel components contained in different audio streams together, a conventional system decodes these channel components, converts the results of decoding into analog signals, and mixes the analog signals using a predetermined mixing method. The signal obtained by mixing is also an analog signal. However, in general, the capacity of a transmission line connecting a player and an amplifier is insufficient to transmit audio data in the form of an analog signal. Accordingly, the analog signal often needs to be encoded (i.e., compressed, and transmitted). For the encoding of an analog signal, the player further includes an encoder. However, the combined audio stream according to embodiments of the present invention is a digital data stream that can be transmitted to the amplifier 200 via the transmission line 400 without an encoder. It is understood that, while an encoder is not required, embodiments of the present invention may use an encoder.

Further, in a conventional system, it is difficult to determine the types of channels that output audio data to be mixed and output levels of the audio data that are mixed, using only a final output analog signal. Further, it is impossible to track back channel components constituting the output analog signal. Thus, once channel components combine to form an analog signal, it is impossible to use audio data on a per channel basis (for example, to extract audio data from the respective channel components). However, according to embodiments of the present invention, a combined audio stream is produced before mixing of the main audio stream and the auxiliary audio stream, and therefore, a user can mix the main audio stream and the auxiliary audio stream as he or she desires. Further, since the combined audio stream is digital data containing the main audio stream, the auxiliary audio stream, and mixing information, the user can not only extract audio data from respective channel components but is also able to make use of the audio data on a per channel basis.

FIG. 9 illustrates a data structure of mixing information according to an embodiment of the present invention. The mixing information of FIG. 9 includes mixing channel information and mixing coefficient information. More specifically, the mixing channel information specifies which channel components contained in a combined audio stream are to be mixed. The mixing coefficient information specifies a mixing coefficient that determines the output levels of audio data to be mixed. The mixing information may include only one of the mixing channel information and the mixing coefficient information.

Further, the mixing information may include encoding information that specifies a format of an auxiliary audio channel for the combined audio stream. The mixing information also includes synchronization information that specifies the reproduction time required to reproduce audio data from the auxiliary audio channel in phase with audio data from a main audio channel. If a reproducing apparatus has already been provided with encoding information and/or synchronization information for the audio data from the auxiliary audio channel, such information may not included in the mixing information.

The mixing information may also contain buffering information. The buffering information is used to control the amounts of different formats of supplied audio channel components before a mixing process because these audio channel components are decoded at different times. For instance, the buffering information specifies the size of a buffer.

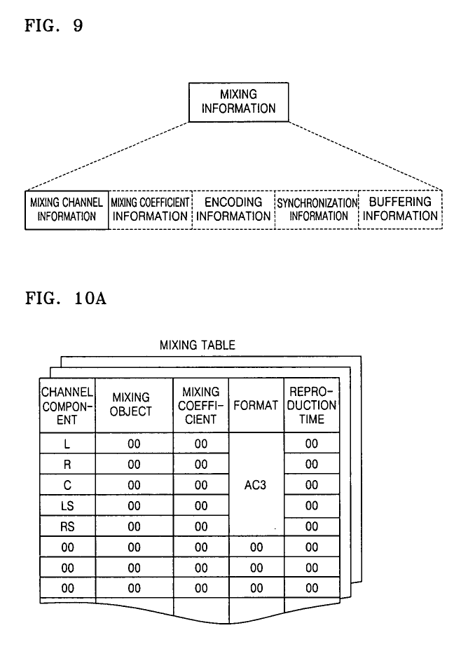

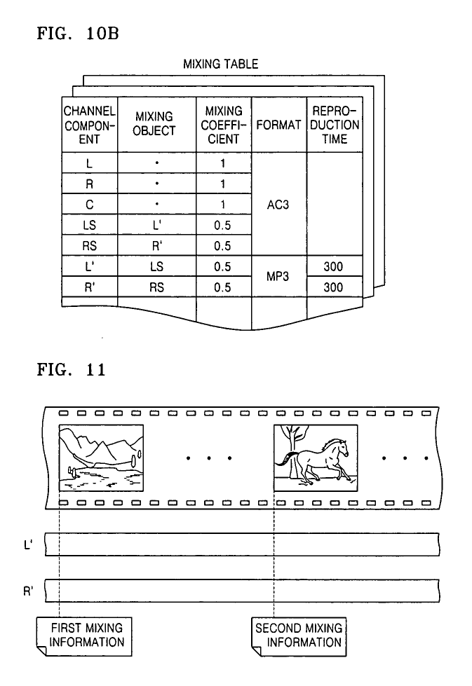

FIGS. 10A and 10B illustrate mixing tables containing the mixing information of FIG. 9, according to preferred embodiments of the present invention. The mixing table of FIG. 10A is related to the main audio stream of FIG. 4A. The mixing table is made in consideration of the mixing of the audio channel components to be added and the existing main audio channel components. The mixing table represents identifiers of the existing main audio channel components and includes a field in which identifiers of the audio channel components to be added will be recorded. In this embodiment, all of the identifiers of the existing main audio channel components are initially set to 00, but they are reset with the identifiers of audio channels that are to be inserted into the main audio channel components.

Identifiers of channel components, which are mixing objects, are all set to 00, but they are also reset with identifiers of channel components to be mixed when an audio channel is inserted into the main audio channel components.

Also, the mixing table includes a field for recording mixing coefficient information specifying the mixing coefficients used to control the output levels of the channel components, a field for recording encoding information specifying the formats of the audio channels, and a field for recording synchronization information specifying the reproduction time of the audio channel components. Similarly, these identifiers are also set to 00, but can be reset by a producer, an apparatus, or a user when audio channels are inserted into the main audio channel components. Here, the value ‘00’ is a dummy value that does not put a restriction on the length of data, but indicates the presence of a field in which additional information is recorded.

Mixing tables of the main audio streams of FIGS. 4D and 4E can also be constructed to be the same as that of FIG. 10A. However, the main audio streams of FIGS. 4D and 4E further include null channels that are to be replaced by the auxiliary channel components to be added. Therefore, identifiers of the main audio streams are not set to 00 but are recorded with information regarding null channel components.

The mixing table of FIG. 10B is related to the combined audio streams of FIGS. 6A and 6B. The mixing table contains mixing channel information specifying identifiers of the audio channel components, (i.e., the main and auxiliary audio channel components) which are input to the mixer 22, the channel components to be mixed, and contains mixing information specifying mixing coefficients for controlling the output levels of the channel components. Also, the mixing table contains encoding information specifying the formats of the respective audio channels and synchronization information specifying the reproduction time of the auxiliary audio channel components.

According to the mixing table of FIG. 10B, the output levels of audio data obtained from main channels L, R, and C are multiplied by a mixing coefficient of 1, and the output levels of audio data from channels LS and RS are multiplied by a mixing coefficient of 0.5. That is, the output levels of audio data from the channels LS and RS are halved and the adjusted audio data is combined with audio data from auxiliary channels L′ and R′. Meanwhile, the output levels of audio data from the auxiliary channels L′ and R′ are multiplied by a mixing coefficient 0.5. That is, the output levels of audio data from the auxiliary channels L′ and R′ are also reduced by half and the adjusted audio data is combined with the audio data from the channels LS and RS.

Also, the mixing table in FIG. 10B reveals that the main audio channel components are made in an AC3 format, the auxiliary audio channel components are made in an MP3 format, and reproduction of the auxiliary audio channel component begins at reproduction time 300.

FIG. 11 is a reference diagram illustrating dynamic mixing according to an embodiment of the present invention. The reference diagram of FIG. 11 illustrates dynamic mixing performed on audio data contained in video when the auxiliary audio channels L′ and R′ contained in the combined audio stream or an auxiliary audio stream are reproduced together with the main channel components contained in the combined audio stream or main audio channels. In this case, using a fixed mixing coefficient when reproducing the channel components output from the auxiliary audio channels L′ and R′ often does not provide a high quality audio experience. For example, this might apply when a movie is shown with a movie producer's narration. If the narration is reproduced at the same output level in both a quiet scene and a noisy battle scene, the output level might be too high to match the atmosphere of the quiet scene or too low during the noisy battle scene. To solve this problem, it is recommended that a content provider provide a plurality of mixing tables which lists mixing coefficients for appropriately adjusting the output levels of the audio data to match the atmospheres of respective scenes in a movie. If the number of mixing tables is more than one, reference timing information should also be provided. The reference timing information specifies instances in time when the mixer 22 of the reproducing apparatus, shown in FIG. 3 or 8B, should refer to the plurality of mixing tables. The mixer 22 enables dynamic mixing by adjusting the output levels of different audio data as instructed by the reference timing information, in which the output levels are multiplied by different mixing coefficients listed in the plurality of mixing tables.

Likewise, it is recommended that a plurality of mixing tables are made so that dynamic mixing can be performed with various mixing channel information, formats, and reproduction time information.

As described above, according to aspects of the preset invention, it is possible to mix different types of channel components output from different audio streams and reproduce them as an audio stream. Also, it is also possible to perform dynamic mixing on multiple channel components, thus enabling adaptation to a change in audio content and characteristics thereof and thereby reproducing audio data more appropriately. Furthermore, a combined audio stream according to aspects of the present invention is digital data that can be easily transmitted and reused on a per channel basis. While described in terms of audio data, it is understood that one or more of the channels could be non-audio data for reproduction, such as text, programs, menus, images or video to be reproduced in conjunction with the audio data.

A method of constructing an audio stream according to aspects of the present invention can be realized as a program executed by a computer. Codes and code segments constituting the program can be easily derived by computer programmers in this art. Also, the program is stored in a computer readable medium and read and executed by a computer to realize the method. The computer readable medium may be a magnetic recording medium, an optical recording medium, or a carrier wave medium.

Although a few embodiments of the present invention have been shown and described, it would be appreciated by those skilled in the art that changes may be made in this embodiment without departing from the principles and spirit of the invention, the scope of which is defined in the claims and their equivalents.

1. An information storage medium for use with a recording and/or reproducing apparatus, comprising:
a multiplicity of audio channel components each containing corresponding audio data; and
mixing information that is used by the apparatus to mix additional channel components to be added with the audio channel components.

2. The information storage medium of claim 1, wherein the mixing information comprises a field in which information regarding the additional channel components is recorded.

3. The information storage medium of claim 2, wherein predetermined dummy values are set in the field.

4. The information storage medium of claim 1, wherein the mixing information comprises at least one of mixing channel information specifying to the apparatus the audio channel components and the additional channel components to be mixed by the apparatus, mixing coefficient information specifying to the apparatus output levels of the audio channel components and the additional channel components, encoding information specifying formats of the audio channel components and the additional channel components to be mixed by the apparatus, and synchronization information specifying to the apparatus reproduction time of the audio channel components and the additional channel components to be mixed by the apparatus.

5. An information storage medium for use with a recording and/or reproducing apparatus, comprising:
a multiplicity of audio channel components comprising audio data; and
an audio stream comprising at least one null channel component which provides a spare space for recording predetermined audio data and the multiplicity of the audio channel components by the apparatus.

6. The information storage medium of claim 5, wherein the null channel component is unoccupied so that predetermined audio data can be stored therein.

7. The information storage medium of claim 5, wherein the null channel component is filled with null data.

8. The information storage medium of claim 5, wherein the multiplicity of audio channels include all channels that complete an audio stream in a predetermined format.

9. The information storage medium of claim 5, wherein the predetermined audio data recordable in the null channel component by the apparatus further comprises mixing information that is referred to by the apparatus when the predetermined audio data contained in the null channel component is mixed by the apparatus with a channel component from at least one of the multiplicity of audio channel components.

10. The information storage medium of claim 9, wherein the mixing information comprises mixing channel information specifying to the apparatus channels of the channel components to be mixed.

11. The information storage medium of claim 9, wherein the mixing information further comprises mixing coefficient information specifying to the apparatus output levels of the channel components to be mixed.

12. The information storage medium of claim 9, wherein the mixing information further comprises encoding information that is referenced by the apparatus to decode the audio data recorded in the null channel.

13. The information storage medium of claim 9, wherein the mixing information further comprises synchronization information specifying to the apparatus reproduction time of the predetermined audio data contained in the null channel.

14. The information storage medium of claim 9, wherein the mixing information is recorded in a header of the audio stream.

15. The information storage medium of claim 5, further comprising an auxiliary audio stream with at least one audio channel including audio data to be recorded in the null channel.

16. An apparatus, comprising:
a main demultiplexer that demultiplexes a main audio stream including a multiplicity of main audio channels having audio data and at least one null channel that provides a space to store predetermined audio data, and outputs the demultiplexed audio stream in main channels;
an auxiliary demultiplexer that demultiplexes an auxiliary audio stream including at least one auxiliary audio channel having audio data, which is to be stored in the null channel, and outputs the demultiplexed audio stream in auxiliary channels;
a mapper that replaces one of the at least one null channels output from the main demultiplexer with one of the at least one auxiliary audio channels output from the auxiliary demultiplexer; and
a multiplexer that multiplexes the at least one auxiliary audio channel output from the mapper and the main audio channel output from the main demultiplexer and outputs a combined audio stream.

17. The apparatus of claim 16, wherein the null channel is unoccupied to store predetermined audio data.

18. The apparatus of claim 16, wherein the null channel is filled with null data.

19. The apparatus of claim 16, wherein the multiplexer outputs the combined audio stream containing mixing information used to mix the audio data contained in the at least one auxiliary channel, which is to be stored in the null channel, and the audio data output from at least one channel of the multiplicity of audio channels.

20. The apparatus of claim 19, wherein the mixing information comprises mixing channel information specifying the channels to be mixed.

21. The apparatus of claim 19, wherein the mixing information further comprises mixing coefficient information specifying output levels of the channels to be mixed.

22. The apparatus of claim 19, wherein the mixing information comprises at least one of encoding information that is used to decode the audio data contained in the at least one auxiliary channel, which is to be stored in the null channel, and synchronization information that specifies reproduction time of the audio data.

23. The apparatus of claim 19, further comprising:
a decoder that decodes the combined audio stream into separate audio channels; and
a mixer that mixes the separate audio channels decoded by the decoder based on the mixing information.

24. An apparatus, comprising:
a decoder that decodes a combined audio stream having a multiplicity of main audio channels which form an audio stream having a predetermined format, and auxiliary audio channels to be mixed with one of the multiplicity of main audio channels; and
a mixer that mixes audio data from the auxiliary audio channels and the main audio channels based on mixing information.

25. The apparatus of claim 24, wherein the mixer mixes the audio data based on the mixing information recorded in a header of the combined audio stream.

26. The apparatus of claim 24, wherein the decoder decodes the audio data contained in the auxiliary audio channels based on encoding information and reproduction time information stored in the mixing information.

27. The apparatus of claim 24, wherein the mixer mixes the audio data from the auxiliary audio channels and the main audio channels, based on the mixing information comprising mixing channel information and mixing coefficient information.

28. A method of constructing an audio stream, comprising:
creating at least one main audio channel component; and
constructing the audio stream by packaging mixing information used to mix the created main audio channel component and additional channel components to be added.

29. The method of claim 28, wherein the constructing the audio stream further comprises creating the mixing information to include fields for recording information regarding the additional channel components.

30. The method of claim 29, wherein the constructing the audio stream further comprises creating the mixing information to include fields for recording information regarding the additional channel components, the information setting the fields to predetermined dummy values.

31. A method of constructing an audio stream, comprising:
creating at least one main audio channel; and
creating a main audio stream having the created main audio channel component and at least one null channel component.

32. The method of claim 31, further comprising:
creating at least one auxiliary audio channel component; and
creating a combined audio stream by replacing the created auxiliary audio channel component with the null channel component.

33. A method of constructing an audio stream, comprising:
creating at least one main audio channel component;
creating at least one auxiliary audio channel component; and
creating a combined audio stream with the created main audio channel component and auxiliary audio channel component.

34. A digital mixer system, comprising:
a first demultiplexer demultiplexing a main digital stream having a plurality of main channels and an auxiliary digital stream having at least one auxiliary channel;
a mapper exchanging at least one of the plurality of main channels with the at least one auxiliary channel; and
a multiplexer multiplexing the remaining plurality of the main channels with the exchanged auxiliary audio channel to create a combined stream.

35. The system of claim 34, wherein the first demultiplexer comprises:
a main demultiplexer demultiplexing the main digital stream into the plurality of main channels; and
an auxiliary demultiplexer demultiplexing the auxiliary digital stream into the at least one auxiliary channel.

36. The system of claim 34, wherein the multiplexer inserts mixing information, which is used in reproduction, in a header of the combined stream.

37. The system of claim 36, wherein the mixing information comprises mixing channel information specifying the main channels and the at least one auxiliary channel to be mixed.

38. The system of claim 37, wherein the mixing information further comprises mixing coefficient information specifying output levels of the main channels and the at least one auxiliary channel to be used during the reproduction.

39. The system of claim 38, wherein the mixing information comprises synchronization information specifying a reproduction time of the at least one auxiliary channel during reproduction.

40. A method of digitally mixing audio, comprising:
demultiplexing a main digital audio stream having a plurality of main audio channels and an auxiliary digital audio stream having at least one auxiliary audio channel;
exchanging at least one of the plurality of main audio channels with the at least one auxiliary audio channel;
multiplexing the remaining plurality of the main audio channels with the exchanged auxiliary audio channel to create a combined audio stream;
storing mixing information specifying output levels of the main audio channels and the at least one auxiliary audio channel to be used during the reproduction and synchronization information specifying a reproduction time of the at least one auxiliary audio channel during reproduction;
decoding the combined audio stream into a plurality of reproduction audio channels corresponding to the main audio channels and the at least one auxiliary channel; and
selecting at least two of the plurality of decoded audio channels and mixing the selected decoded audio channels according to the mixing information.

41. A method of generating a combined audio stream, comprising:
receiving at least two audio input steams, a first one of the at least two audio input streams comprises a five channel surround sound audio stream, and a second one of the at least two audio input streams comprises a two channel auxiliary audio stream;
exchanging at least one of the five channels from the first one of the at least two audio input streams with at least one of the auxiliary audio channels from the second one of the at least two audio input streams;
generating mixing information specifying output levels of the remaining ones of the five channels from the first one of the at least two audio input streams and the at least one exchanged auxiliary audio channel; and
generating the combined audio stream based on the remaining ones of the five channels from the first one of the at least two audio input streams and the at least one exchanged auxiliary audio channel and the mixing information.

42. An information carrier wave signal for use with a recording and/or reproducing apparatus, the carrier wave signal comprising:
a multiplicity of audio streams each comprising corresponding audio channel components; and
mixing information that is used by the apparatus to mix additional channel components to be added with selected ones of the audio channel components by the apparatus.
